(19) United States
(12) Patent Application Publication
(10) Pub. No.: US 2026/0149872 A1
(43) Pub. Date: May 28, 2026

(54) IMAGE PICKUP APPARATUS PROVIDED WITH PHOTOGRAPHING ASSIST FUNCTION, CONTROL METHOD, AND STORAGE MEDIUM

(71) Applicant: CANON KABUSHIKI KAISHA, Tokyo (JP)

(72) Inventor: HIRONORI KAIDA, Kanagawa (JP)

(21) Appl. No.: 19/389,525

(22) Filed: Nov. 14, 2025

(30) Foreign Application Priority Data
Nov. 26, 2024 (JP) 2024-205470

(51) Int. Cl. H04N 23/63; H04N 23/53; H04N 23/60

(52) U.S. Cl. CPC H04N 23/632; H04N 23/53; H04N 23/64

(57) ABSTRACT

An image pickup apparatus includes an image sensor, a unit that obtains a request for a photographing effect, a unit that converts the request into a prompt, a unit that generates photographing parameters and a proposed photographing image, in which the photographing effect becomes maximum, by using a machine learning algorithm from input data including a live view image obtained by the image sensor, photographing parameters linked to the live view image, and the prompt, a component that adjusts the photographing effect, a unit that generates photographing parameters with which the adjusted photographing effect can be obtained by using the machine learning algorithm, and a unit that, when an operation is performed, performs a photographing preparation by using the photographing parameters with which the adjusted photographing effect is capable of being obtained, and a display unit that switchably displays at least the live view image and the proposed photographing image.

### BACKGROUND

### Field of the Technology

The present disclosure relates to an image pickup apparatus, a control method, and a storage medium, and more particularly to an image pickup apparatus provided with a photographing assist function that utilizes a machine learning algorithm to assist with a photographing setting performed by a user, a control method, and a storage medium.

### DESCRIPTION OF THE RELATED ART

In recent years, with an image pickup apparatus such as a digital camera, a user has had to manually adjust many photographing parameters, such as a shutter speed, an aperture, and an ISO sensitivity, in order to perform an optimal photographing setting that suits a photographing scene. For this reason, in particular, it is difficult for a user who is unfamiliar with photographing to perform photographing as intended by himself/herself. Although there are automatic modes (for example, “a programmed auto function”) in which the image pickup apparatus determines the many photographing parameters that have been described above, even these automatic modes do not guarantee optimal results in all situations (in all photographing scenes).

On the other hand, Japanese Laid-Open Patent Publication (kokai) No. 2019-213130 discloses a trained model that, when a photographed image that has been captured by a photographing apparatus is inputted, outputs a photographing scene of the photographed image, and recommended camera setting items and their adjustment ranges for the determined photographing scene. The technique disclosed in Japanese Laid-Open Patent Publication (kokai) No. 2019-213130 allows a user to easily perform a photographing setting in accordance with the photographing scene by adjusting photographing parameters (the camera setting items) within the adjustment ranges thereof.

However, with the technique disclosed in Japanese Laid-Open Patent Publication (kokai) No. 2019-213130, since only the recommended camera setting items are capable of being adjusted by the user, in the case where the determination result of the photographing scene, which is obtained by the trained model, does not match the user's preferences, there is a possibility that it becomes difficult to achieve a photographing setting desired by the user. Furthermore, in the case where there are a plurality of camera setting items that need to be adjusted, the user will be forced to perform a complicated photographing setting operation.

### SUMMARY

The present disclosure provides an image pickup apparatus, a control method, and a storage medium that allow even a user who is unfamiliar with photographing to easily obtain a photograph as intended by himself/herself.

Accordingly, a first aspect of the present disclosure provides an image pickup apparatus comprising an image sensor, a request obtaining unit configured to obtain a request for a photographing effect from a user, at least one processor and/or circuit configured to function as a converting unit that converts the request for the photographing effect into a prompt, a first generating unit that generates, as output data, photographing parameters and a proposed photographing image, in which the photographing effect becomes maximum, by using a machine learning algorithm from input data including a live view image that has been obtained by the image sensor, photographing parameters linked to the live view image, and the prompt, an adjustment component that adjusts the photographing effect in a range from zero to maximum in response to a first user operation, a second generating unit that generates photographing parameters with which the adjusted photographing effect is capable of being obtained by using the machine learning algorithm, and a photographing preparation unit that, when a second user operation is performed, performs a photographing preparation by using the photographing parameters with which the adjusted photographing effect is capable of being obtained, and an image display unit configured to display at least the live view image in which the photographing effect is zero and the proposed photographing image in which the photographing effect becomes maximum in a switchable manner.

Accordingly, a second aspect of the present disclosure provides an image pickup apparatus connected to a generating apparatus, the image pickup apparatus comprising an image sensor, a request obtaining unit configured to obtain a request for a photographing effect from a user, at least one processor and/or circuit configured to function as a converting unit that converts the request for the photographing effect into a prompt, a first data transmitting and receiving unit that transmits, to the generating apparatus, first communication data including a live view image that has been obtained by the image sensor, photographing parameters linked to the live view image, and the prompt, and receives, from the generating apparatus, photographing parameters and a proposed photographing image, in which the photographing effect becomes maximum, the photographing parameters and the proposed photographing image being generated by using a machine learning algorithm from the first communication data, an adjustment component that adjusts the photographing effect in a range from zero to maximum in response to a first user operation, a second data transmitting and receiving unit that transmits, to the generating apparatus, a photographing effect value indicating a magnitude of the adjusted photographing effect, and receives, from the generating apparatus, photographing parameters with which the adjusted photographing effect is capable of being obtained and a proposed photographing image in which the adjusted photographing effect is capable of being obtained, the photographing parameters and the proposed photographing image being generated by using the machine learning algorithm from the photographing effect value, and a photographing preparation unit that, when a second user operation is performed, performs a photographing preparation by using the photographing parameters with which the adjusted photographing effect is capable of being obtained, and an image display unit configured to display at least the live view image in which the photographing effect is zero and the proposed photographing image in which the photographing effect becomes maximum in a switchable manner.

Features of the present disclosure will become apparent from the following description of embodiments with reference to the attached drawings. The following description of embodiments is described by way of example.

### BRIEF DESCRIPTION OF THE DRAWINGS

FIG. 1A is a schematic cross-sectional view of an image pickup apparatus according to a first embodiment of the present disclosure.

FIG. 1B is a block diagram that illustrates a hardware configuration of the image pickup apparatus shown in FIG. 1A.

FIG. 2 is an external appearance view of the image pickup apparatus shown in FIG. 1A.

FIG. 3 is a flowchart of a setting change processing according to the first embodiment of the present disclosure.

FIG. 4 is a diagram for explaining a proposed photographing image adjustment mode according to the first embodiment of the present disclosure.

FIG. 5 is a diagram that illustrates a configuration example of a prompt generating unit and a generating unit that are shown in FIG. 1B.

FIG. 6 is a diagram that illustrates a modified configuration example of the generating unit.

FIG. 7 is a flowchart of a setting change processing performed on the side of an image pickup apparatus of an image pickup system according to a second embodiment of the present disclosure.

FIG. 8 is a flowchart of a setting change processing performed on the side of a generating apparatus of the image pickup system according to the second embodiment of the present disclosure.

FIG. 9 is a block diagram that illustrates a hardware configuration of the image pickup apparatus according to the second embodiment of the present disclosure.

FIG. 10 is a diagram that illustrates a configuration of the image pickup system according to the second embodiment of the present disclosure.

### DESCRIPTION OF THE EMBODIMENTS

The present disclosure will now be described in detail below with reference to the accompanying drawings showing embodiments thereof.

Hereinafter, embodiments of the present disclosure will be described in detail with reference to the accompanying drawings. It should be noted that the following embodiments do not limit the invention as defined by the claims. In addition, although the embodiments describe a plurality of features, not all of the plurality of features are essential to the present disclosure, and the plurality of features may be combined in any desired manner. Furthermore, in the accompanying drawings, the same or similar configurations (components) are given the same reference numerals, and duplicate descriptions will be omitted.

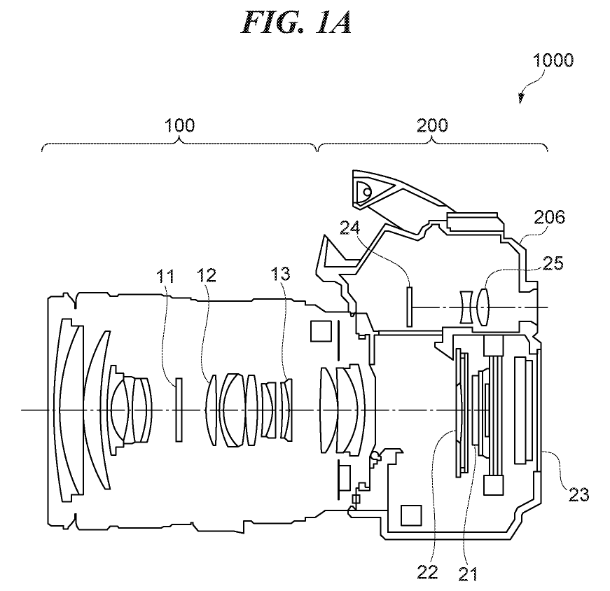

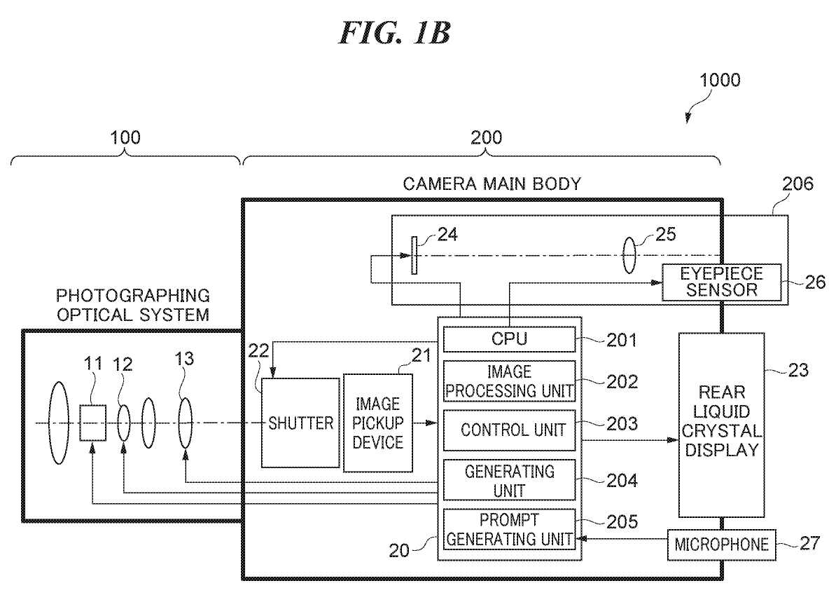

First, a first embodiment of the present disclosure will be described. FIG. 1A is a configuration diagram (a schematic cross-sectional view) of an image pickup apparatus 1000 according to the first embodiment of the present disclosure.

As shown in FIG. 1A, the image pickup apparatus 1000 is configured to include a photographing optical system 100 and a camera main body 200.

The photographing optical system 100 includes a diaphragm (an aperture) 11, an image stabilization lens group 12, and a focus lens group 13, and is capable of directing an optical image to the camera main body 200.

The camera main body 200 includes an image pickup device (an image sensor) 21 that photoelectrically converts an optical image from the photographing optical system 100, and a mechanical shutter 22 that adjusts an exposure time. In addition, the camera main body 200 includes, as display units, a rear liquid crystal display 23 (a rear panel) on the rear surface portion, and a small liquid crystal display 24 provided together with an optical system 25 in a viewfinder unit 206 (an electronic viewfinder (EVF)) on the top portion. These display units (the rear liquid crystal display 23 and the small liquid crystal display 24) are capable of displaying images captured by the image pickup device 21. It should be noted that the image pickup device 21 may be an image pickup device (an image sensor) provided with an electronic shutter function. In this case, the mechanical shutter is not necessary, and even in the case where the mechanical shutter is provided, the mechanical shutter remains fully open when the exposure time is adjusted by the electronic shutter.

In the case of performing photographing, when a user lightly presses a shutter button (not shown) to the first position, that is, when the user performs so-called “half-pressing” of the shutter button, setting of photographing parameters such as a shutter speed and an aperture value is performed by automatic focusing and automatic exposure mechanisms. Furthermore, when the user presses the shutter button from “half-pressing” to the second position, that is, when the user performs so-called “full-pressing” of the shutter button, the mechanical shutter 22, or the electronic shutter function of the image pickup device 21 is activated to perform image picking up (capture an image).

FIG. 1B is a block diagram that illustrates a hardware configuration of the image pickup apparatus 1000.

In addition to the above-described components, the camera main body 200 also includes an electric circuit 20 and a microphone 27.

The electric circuit 20 is implemented with a central processing unit (a CPU) 201, an image processing unit 202, a control unit 203, a generating unit 204, a prompt generating unit 205, etc.

The diaphragm 11, the image stabilization lens group 12, the focus lens group 13, and the mechanical shutter 22 are each controlled by the control unit 203 via a driving means (not shown).

Signals photoelectrically converted by the image pickup device 21 are capable of being converted into digital data via the image processing unit 202 and being saved (stored) in a recording medium (not shown).

The viewfinder unit 206 is further provided with an eyepiece sensor 26 that is capable of detecting whether or not the user has brought his/her eye in contact with the viewfinder unit 206.

The prompt generating unit 205 (a converting unit) generates a prompt from voice data inputted through the microphone 27. In addition, the generating unit 204 includes a trained model such as a machine-learned neural network, and inputs photographed image data (captured image data) into the trained model to generate a proposed photographing image that is a new image, and photographing parameters for photographing (capturing) the proposed photographing image. Details will be described below.

The CPU 201 is a processing unit that is capable of electrically controlling all of the above-described components. In FIG. 1B, control signal lines are omitted, and only the flow of information between the respective components is indicated by arrows.

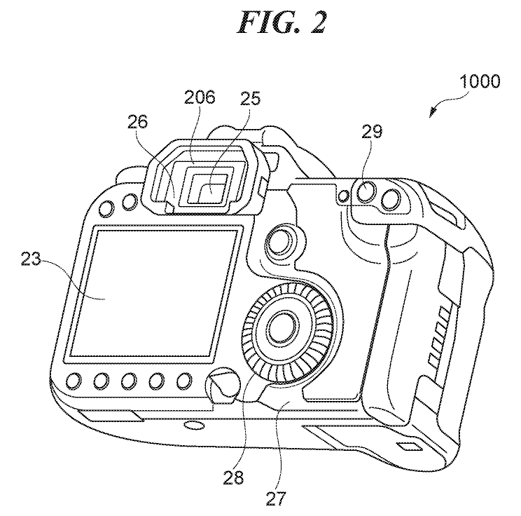

FIG. 2 is an external appearance view of the image pickup apparatus 1000 when viewed from the rear.

In FIG. 2, the same reference numerals are used for the components as in FIG. 1A and FIG. 1B, and duplicate descriptions will be omitted.

The user changes the photographing parameters by using an operation unit 29 configured to include buttons and the like attached to the image pickup apparatus 1000, and an electronic dial 28 (setting change means), and then performs photographing. It should be noted that in the case where the rear liquid crystal display 23 has a touch panel function, it may be possible to change the photographing parameters by a touch operation on the rear liquid crystal display 23 (the setting change means).

The user is able to understand (grasp) the current setting status of the photographing parameters through the display output or the like performed by the rear liquid crystal display 23 or the small liquid crystal display 24. In addition, the adjustment or change of a photographing effect with respect to a proposed photographing image that is being displayed on the rear liquid crystal display 23 or the small liquid crystal display 24, which is the display unit, is also performed by using the electronic dial 28 or the operation unit 29.

<Regarding photographing parameters generated by the generating unit 204>

The photographing parameters generated by the generating unit 204 are not particularly limited. For example, as parameters for photographing (capturing) a bright image, typical parameters include the ISO sensitivity, the shutter speed, exposure, white balance, image contrast, and the aperture value, which adjusts the depth of a subject. Needless to say, other camera setting items (other parameters) that affect the photographing effect of the photographed image are also capable of being included in the photographing parameters. For example, saturation, sharpness, lighting correction, tone priority, photographing style, noise reduction, color correction, and an image processing setting may also be included in the photographing parameters.

In addition, different users have different photographic preferences, and for example, in the case where a user wants to focus on a plurality of subjects, or in the case where a user wants to focus on a specific subject, information about a focus position (a focus setting and a subject tracking setting) may also be included in the photographing parameters.

The generating unit 204 is a processing unit including a trained model that is capable of presenting a proposed photographing image having taken into account the user's photographic preferences, the photographing situation, etc., to which a photographing effect has been added, and the trained model is configured with, for example, a multi-layer neural network.

In the first embodiment, the trained model of the generating unit 204 has learned the user's preferences in advance (has been trained in advance with the user's preferences) before photographing for each of lens types of photographing optical systems and camera types of camera main bodies of a plurality of image pickup apparatuses including the image pickup apparatus 1000. Using this trained model, an inference processing is performed by using a live view image before photographing as input, and photographing parameters and a proposed photographing image are generated. Thereafter, the generating unit 204 outputs an adjustment screen, which allows the user to adjust the proposed photographing image, on the rear liquid crystal display 23 or the viewfinder unit 206.

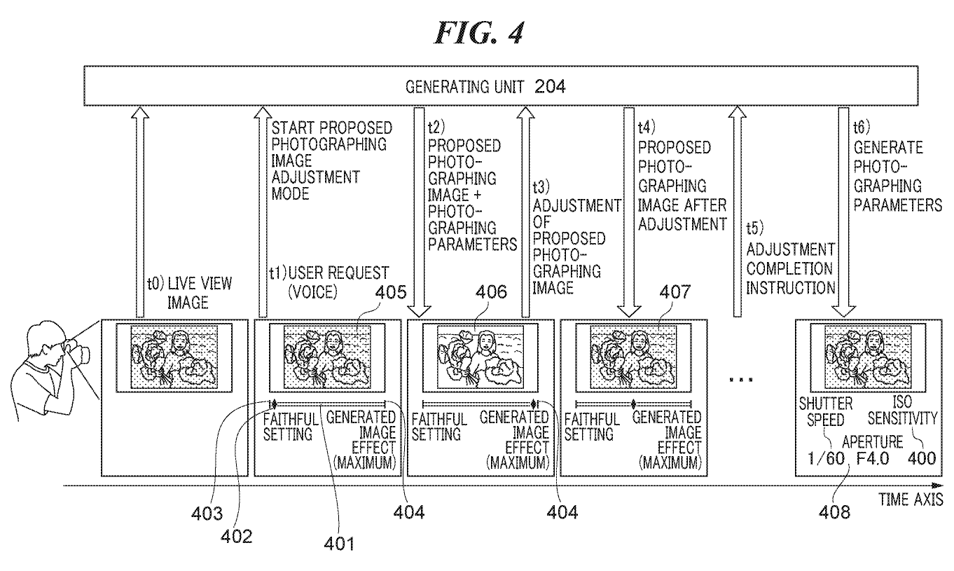

In addition, a photographing effect value x (x is a variable in a range of 0 to 1) indicating a magnitude of the photographing effect of the proposed photographing image compared to the live view image before photographing is also input data of this trained model. When the photographing effect value x is changed from an initial value (=1) at which the photographing effect becomes maximum, the inference processing is performed again by using the changed photographing effect value x. Here, the photographing effect value x is changed in response to a user operation on the adjustment screen, as will be described below with reference to FIG. 4.

It should be noted that the learning method (the training method) of the trained model provided in the generating unit 204 will be described below.

<A processing flow from the generation of a proposed photographing image performed by the generating unit 204 to setting change>

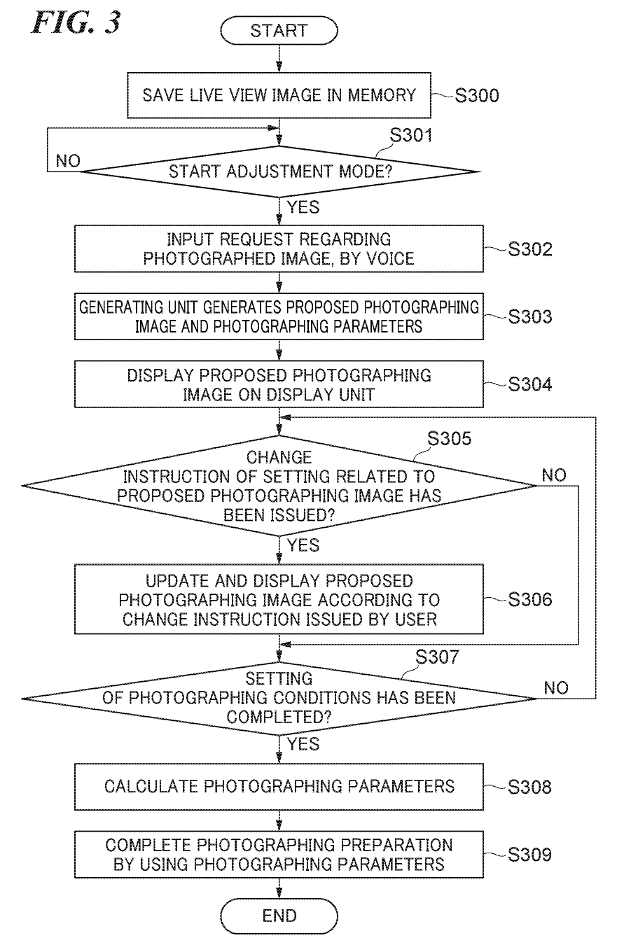

FIG. 3 is a flowchart of a setting change processing of the photographing parameters of the image pickup apparatus 1000 in the first embodiment. The setting change processing of FIG. 3 is realized by the CPU 201 sending commands to the control unit 203 and controlling the respective units (the respective components) of the image pickup apparatus 1000.

It should be noted that in the first embodiment, the setting change processing of FIG. 3 is started when the user's eye being in contact with the eyepiece sensor 26 is detected. In addition, in the first embodiment, the small liquid crystal display 24 will be referred to as the display unit hereinafter, but the rear liquid crystal display 23, or both the rear liquid crystal display 23 and the small liquid crystal display 24, may also function as the display unit.

As shown in FIG. 3, in a step S300, the control unit 203 retains (saves) a live view image output from the image pickup device 21 in a memory (not shown). Here, photographing of the live view image is performed under exposure conditions automatically set and calculated in a P mode (by programmed auto). The photographing parameters used at the time of the photographing of the live view image, including these exposure conditions, are also linked to the live view image, which has been retained in the memory, and saved.

In a step S301, the control unit 203 starts an adjustment mode for a proposed photographing image (a proposed photographing image adjustment mode) in response to a predetermined user operation performed with respect to the image pickup apparatus 1000.

In a step S302, the control unit 203 receives, as voice data, a request from the user regarding a photographing setting of the image pickup apparatus 1000. Specifically, when the user vocalizes the request regarding the photographing setting of the image pickup apparatus 1000, the microphone 27 (a request obtaining unit) obtains the voice, converts the obtained voice into voice data, and transmits the voice data to the prompt generating unit 205. The prompt generating unit 205 performs character recognition with respect to the voice data obtained from the microphone 27 to generate (convert) a prompt, and inputs the prompt into the generating unit 204.

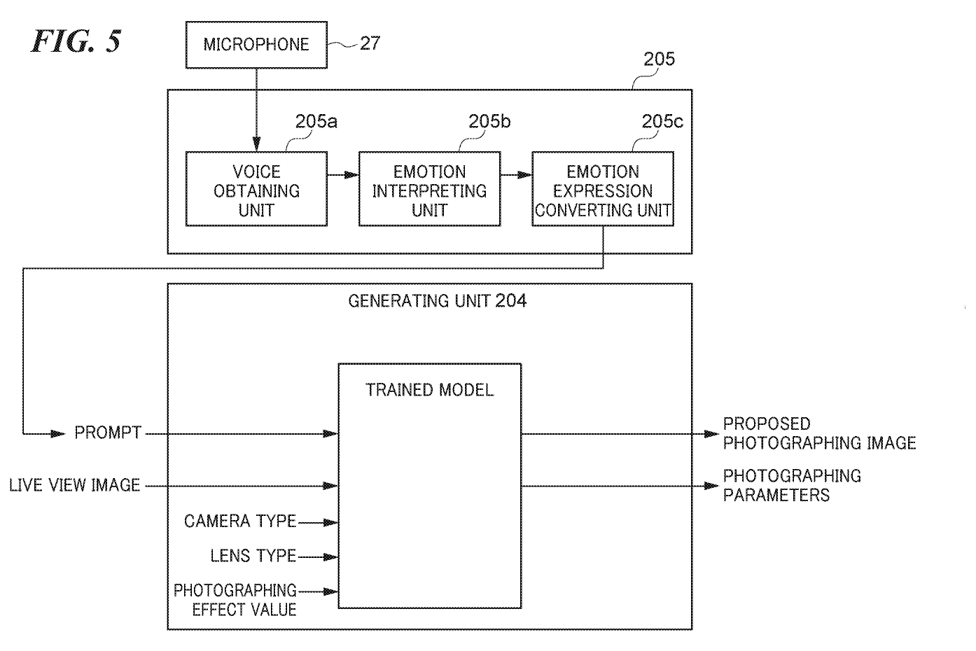

Hereinafter, the prompt generation method in the prompt generating unit 205 will be described with reference to FIG. 5.

In the first embodiment, the prompt generating unit 205 interprets the user's sensibilities and emotions from the user's voice information (the voice data) and outputs the expressions of these sensibilities and emotions as a prompt. As shown in FIG. 5, the prompt generating unit 205 includes a voice obtaining unit 205a, an emotion interpreting unit 205b, and an emotion expression converting unit 205c, and performs this prompt output by using the functions of these three units (the voice obtaining unit 205a, the emotion interpreting unit 205b, and the emotion expression converting unit 205c). This allows the user to easily convey him/her request for a photographing scene by using expressions based on him/her own sensibilities, and the generating unit 204 becomes able to propose an optimal photographing setting based on those sensibilities.

The voice obtaining unit 205a obtains the voice data of the user's voice from the microphone 27, converts the obtained voice data into text data by using a voice recognition algorithm, and transmits the text data to the emotion interpreting unit 205b. In the first embodiment, the voice obtaining unit 205a implements a cloud-based voice recognition API such as Google Speech-to-Text or Microsoft Azure Speech Service, and converts the obtained voice data into text data. Specifically, when the voice obtaining unit 205a obtains the voice data of the user's voice by using the microphone 27, the voice obtaining unit 205a transmits the obtained voice data to the voice recognition API, and then obtains text data that has been generated by converting the voice data using the voice recognition API.

The emotion interpreting unit 205b interprets the user's emotions and sensibilities from the text data that has been transmitted from the voice obtaining unit 205a, and then transmits the interpretation result to the emotion expression converting unit 205c. Specifically, the emotion interpreting unit 205b performs a natural language processing with respect to the obtained text data to extract keywords relating to emotions and sensibilities from the content of the user's statement, and converts the content of the user's statement into keywords relating to emotions and sensibilities.

In the natural language processing, a text analysis technique is first used to understand the context and dependencies of the text data, and then an emotion analysis technique is used to extract the user's emotions from the text data.

Here, the text analysis technique is a technique that performs morphological analysis, dependency structure analysis, and context analysis.

In the morphological analysis, dividing the text data into words and identifying the part of speech of each divided word are performed. The emotion interpreting unit 205b performs the morphological analysis by implementing a morphological analysis engine such as MeCab or Kuromoji.

In the dependency structure analysis, analyzing the dependencies between morphologically analyzed words and understanding the structure of the sentence based on the analysis results are performed. The emotion interpreting unit 205b performs the dependency structure analysis by implementing a dependency structure analysis engine such as spaCy or Stanford Parser.

In the context analysis, a trained model is used, and understanding the meaning of a whole sentence, and the interpretation that is based on the context of the meaning of a specific word or phrase are performed. It should be noted that as the trained model used in the context analysis, an existing neural network such as BERT, GPT-3, or GPT-4 may be used, or an original neural network may be constructed. For example, an original neural network may be constructed that, based on comments entered by the user regarding the photographs he/she has taken, analyzes (learns) the brightness, the composition, the depth of field, the focal length, white balance, etc. of the subject from the photographs taken by the user and performs the context analysis.

In addition, the emotion analysis technique is a technique that extracts the user's emotions from the text data. By using the emotion analysis technique, it is possible to generate a prompt that is based on the user's emotions. The emotion interpreting unit 205b may implement an emotion dictionary such as SentiWordNet to analyze the user's emotion corresponding to a specific word or phrase on a rule-based basis. Alternatively, the emotion interpreting unit 205b may implement a trained model that has been trained (machine-learned) in advance by using emotion-labeled datasets to analyze the user's emotion corresponding to a specific word or phrase. Examples of the trained model implemented here include a support vector machine (SVM), a random forest, and deep learning models (Long Short-Term Memory (LSTM) and Bidirectional Encoder Representations from Transformers (BERT)).

It should be noted that any technique capable of extracting the user's emotions from data other than text data may be used instead of the emotion analysis technique described above (or may be used in combination with the emotion analysis technique described above). For example, a voice feature value extraction technique may be used in which feature values such as a tone, a pitch, and a speed are extracted from the voice data that has been obtained by the microphone 27, and the user's emotions are extracted by using these feature values. In this case, the emotion interpreting unit 205b implements an acoustic feature value extraction library (for example, OpenSMILE or Librosa) to extract voice feature values. Here, the voice feature value extraction technique is a technique that performs a preprocessing of the voice data, a feature value extraction processing, and a feature value analysis processing. The preprocessing of the voice data refers to processes such as noise removal and normalization, and the feature value extraction processing refers to a processing of extracting the feature values such as the tone, the pitch, and the speed from the preprocessed voice data. In addition, the feature value analysis processing refers to a processing of analyzing the feature values that have been extracted by the feature value extraction processing and estimating emotions.

The emotion expression converting unit 205c converts the interpretation result that has been transmitted from the emotion interpreting unit 205b into an ideal expression relating to the photographing scene, generates a prompt, and transmits the prompt to the generating unit 204. For example, in the case where the user has given an instruction by voice via the microphone 27 saying, “I want to make it an emotional (sentimental) expression”, the emotion expression converting unit 205c converts this instruction into a specific prompt such as “depiction in light tones”, “soft depiction of the subject”, and “brighter scene”.

Returning to FIG. 3, in a step S303, the generating unit 204 (a first generating unit) generates a proposed photographing image and photographing parameters based on the live view image that has been retained in the memory in the step S300 and the prompt that has been input from the prompt generating unit 205 in the step S302. Details will be described below, but here, a proposed photographing image, in which the photographing effect becomes maximum, is generated by using a machine learning algorithm.

In a step S304, the control unit 203 causes the display unit to display the proposed photographing image that has been generated by the generating unit 204 in the step S303.

In a step S305, the control unit 203 determines whether or not an instruction to change a setting related to the proposed photographing image (an instruction to change the photographing effect value x) has been issued by the user, that is, determines whether or not a change instruction of the setting related to the proposed photographing image has been issued by the user. The method of issuing the change instruction of the setting related to the proposed photographing image will be described in detail below, but the change instruction of the setting related to the proposed photographing image is issued by a user operation using the operation unit 29 or the electronic dial 28. In the case of being determined that a change instruction of the setting related to the proposed photographing image has been issued (YES in the step S305), the setting change processing of FIG. 3 proceeds to a step S306, and on the other hand, in the case of being determined that a change instruction of the setting related to the proposed photographing image has not been issued (NO in the step S305), the setting change processing of FIG. 3 proceeds to a step S307.

In the step S306, the generating unit 204 (a second generating unit) generates a proposed photographing image, which is based on the change instruction of the setting related to the proposed photographing image, by using the machine learning algorithm. Thereafter, the control unit 203 causes the display unit to display the proposed photographing image that is based on the change instruction of the setting related to the proposed photographing image.

In the step S307, the control unit 203 determines whether or not the setting of the photographing parameters has been completed. Specifically, when the proposed photographing image displayed on the display unit matches the user's desired photographing image (the user's desired photographing impression) and the user has issued an adjustment completion instruction that will be described below, the control unit 203 determines that the setting of the photographing parameters has been completed. In the case of being determined that the setting of the photographing parameters has been completed (YES in the step S307), since there is no need to change the setting of the photographing parameters, the setting change processing of FIG. 3 proceeds to a step S308. On the other hand, in the case where the proposed photographing image displayed on the display unit differs from the user's desired photographing image (the user's desired photographing impression) and an adjustment completion instruction has not been issued, the setting of the photographing parameters is not completed (NO in the step S307), and the setting change processing of FIG. 3 returns to the step S305. In this case, the user again issues a change instruction of the setting related to the proposed photographing image.

In the step S308, photographing parameters for performing photographing of a proposed photographing image according to the user's request are calculated. The calculation method will be described below.

In a step S309, when a photographing preparation for performing the photographing setting is completed by using the photographing parameters that have been calculated in the step S308, the setting change processing of FIG. 3 ends.

As described above, in the setting change processing of FIG. 3, in order to reflect the user's preferences, the processes of the steps S300 to S307 are repeated, and the process of updating the proposed photographing image generated by the generating unit 204 is repeated, thereby matching the user's preferences. As a result, it is possible to realize the photographing preparation using the photographing parameters that are based on the proposed photographing image that has reflected the user's preferences.

Conventionally, the user has had to manually adjust a plurality of photographing parameters for photographing to suit him/her preferred photographing style, forcing him/her to perform a very complicated adjustment. However, the technique according to the present disclosure makes it possible for the user to intuitively and easily set photographing parameters that suit him/her preferences.

<Method of displaying a live view of the proposed photographing image>

FIG. 4 is a diagram for explaining the proposed photographing image to be displayed and updated on the display unit in the step S304 and the step S306 of FIG. 3, and for explaining the method for issuing a setting change instruction (the change instruction of the setting related to the proposed photographing image) in the step S305 of FIG. 3. Hereinafter, the proposed photographing image that is updated on the display unit every time the setting change instruction is issued, and the photographing parameters that are determined and displayed on the display unit when the adjustment completion instruction has been issued will be described with reference to FIG. 4.

As an example, FIG. 4 shows a setting screen of the photographing parameters in the case where the user is about to perform photographing of a portrait in a flower field. FIG. 4 shows a state in which the user is checking a live view image through the viewfinder unit 206.

The live view image shown along a time axis in FIG. 4 shows the display content of the display unit that the user is looking at through the viewfinder unit 206. By executing the setting change processing of the photographing parameters, which is shown in FIG. 3, the proposed photographing image displayed on the display unit is update-displayed in time sequence.

As shown in FIG. 4, at a timing t0, a live view image is photographed (captured) with the image pickup apparatus 1000 by using photographing parameters, which have been determined in accordance with the exposure conditions automatically set and calculated in the P mode (by the programmed auto), and is displayed on the display unit.

At a timing t1, in response to a predetermined user operation performed with respect to the image pickup apparatus 1000, the proposed photographing image adjustment mode is started. At this time, the display unit continues to display the live view image as it is as a proposed photographing image 405, in which the photographing effect is zero (that is, the photographing effect value x is 0). Furthermore, the display unit (an adjustment screen display unit) displays an adjustment bar 401, which adjusts the photographing effect by using a setting adjustment marker 402, below the image. A left end 403 of the adjustment bar 401 indicates a faithful setting (that is, the photographing effect value x is 0), and a right end 404 of the adjustment bar 401 indicates a setting where the photographing effect becomes maximum (that is, the photographing effect value x is 1). At the timing t1, since the current proposed photographing image is in a state where the photographing effect is zero, the setting adjustment marker 402 is displayed at the left end 403.

It should be noted that at the timing t1, when the user vocalizes the request regarding the photographing setting of the image pickup apparatus 1000, the microphone 27 converts the voice into voice data. Furthermore, the prompt generating unit 205 performs character recognition with respect to the voice data to generate text data, and uses the text data to generate a prompt. The generating unit 204 inputs the prompt into the trained model, and generates, as output, a proposed photographing image 406, in which the photographing effect becomes maximum (that is, the photographing effect value x is 1), and photographing parameters for photographing (capturing) the proposed photographing image 406. Even in the case where the user's request regarding the photographing setting of the image pickup apparatus 1000 at this time is a vague request with a high level of abstraction, such as “I want to perform photographing with a photographing effect that makes people stand out”, the generating unit 204 is able to generate an appropriate proposed photographing image by using the trained model that has been retained in advance.

At a timing t2, the proposed photographing image 406, which has been generated by the generating unit 204 based on the request vocalized by the user at the timing t1, is output to the display unit. In addition, since the photographing effect value x of the proposed photographing image 406 is 1, the position of the setting adjustment marker 402 moves to the right end 404. For example, the generating unit 204 outputs, as the proposed photographing image 406, an image in which the depth of the background is shallower and the entire subject is brighter than the proposed photographing image 405 at the timing t0.

Next, at a timing t3, with respect to the proposed photographing image 406, the user moves the setting adjustment marker 402 (an adjustment component) within a range from the left end 403 to the right end 404 of the adjustment bar 401 by using the electronic dial 28 or the operation unit 29 (a first user operation). At this time, the closer the user moves the setting adjustment marker 402 to the position of the left end 403, the closer the proposed photographing image can be to the live view image (the proposed photographing image 405) that has been photographed (captured) with the P mode setting. In other words, the proposed photographing image is capable of being adjusted to an image, in which the photographing effect is weak with respect to the proposed photographing image 405.

In the case where the user feels that the photographing effect of the proposed photographing image 406 displayed on the display unit at the timing t2 is too strong, the user is able to adjust the photographing effect to be weaker by performing adjustment that slides the setting adjustment marker 402 to the left side at the timing t3. In this way, the display unit (an image display unit) displays at least the proposed photographing image 405 and the proposed photographing image 406 in a switchable manner depending on the position of the setting adjustment marker 402.

It should be noted that an update speed of the proposed photographing image displayed on the display unit when the setting adjustment marker 402 is moved does not have to be constant. For example, the update speed at which the proposed photographing image is displayed on the display unit may be changed in accordance with a speed at which the user moves the setting adjustment marker 402 (an operation speed). In other words, in the case where the user moves the setting adjustment marker 402 quickly (the operation speed is equal to or greater than a threshold value), since the user intends to significantly change the photographing effect of the proposed photographing image, the update speed of the proposed photographing image is decreased. On the other hand, when the user is finely adjusting the setting adjustment marker 402 (the operation speed is smaller than the threshold value), since the user intends to finely adjust the photographing effect of the proposed photographing image, the update speed of the proposed photographing image displayed on the display unit is increased. By changing the update speed of the proposed photographing image in this way, it is conceivable that the power consumption of the image pickup apparatus 1000 is capable of being reduced and the burden on the user to check the image is capable of being reduced.

At a timing t4, the generating unit 204 obtains a photographing effect value corresponding to the adjusted position of the setting adjustment marker 402, inputs the obtained photographing effect value into the trained model, and performs inference again to generate a proposed photographing image 407, in which the photographing effect has been adjusted. Thereafter, the generated proposed photographing image 407 is displayed on the display unit. At this time, the generating unit 204 does not need to generate photographing parameters. It should be noted that it is assumed that the trained model used here has undergone additional training (has performed additional learning) in advance using the proposed photographing image 405 (the photographing effect value x = 0) and the proposed photographing image 406 (the photographing effect value x = 1).

The proposed photographing image 407 is a proposed photographing image, in which the photographing effect requested (desired) by the user has been reduced compared to the proposed photographing image 406, and for example, becomes an image, in which the brightness of the subject has been reduced compared to the proposed photographing image 406.

In this way, the user moves the setting adjustment marker 402 until a proposed photographing image, to which the desired photographing effect has been added, is generated. Thereafter, at a timing t5 when a proposed photographing image, to which a satisfactory photographing effect has been added, is displayed on the display unit, the user presses a determination button (not shown) for the proposed photographing image (a second user operation). In response to the pressing of the determination button, an adjustment completion instruction is sent to the generating unit 204.

At a timing t6, the generating unit 204 receives the adjustment completion instruction, obtains a photographing effect value corresponding to the current position of the setting adjustment marker 402, inputs the obtained photographing effect value into the trained model, and performs inference again to generate photographing parameters, for which the photographing effect has been adjusted. The control unit 203 (a photographing preparation unit) performs a photographing preparation for performing the photographing setting by using the generated photographing parameters. At this time, as shown in a screen 408, an image, which is the same as the proposed photographing image that has been displayed at the timing t5, and a list of the photographing parameters that have been generated at the timing t6 may be displayed.

As described above, in the first embodiment, the user is able to select a proposed photographing image, to which a satisfactory photographing effect has been added, simply by referring to the proposed photographing image generated by the generating unit 204 and displayed and updated on the display unit, adjusting the position of the setting adjustment marker 402, and pressing the determination button. In addition, since the photographing parameters, with which the same photographing effect as the selected proposed photographing image is capable of being obtained, are set in the image pickup apparatus 1000 in response to the pressing of the determination button, even with respect to an actual subject, it is possible to perform photographing with the satisfactory photographing effect.

Next, the configuration of the trained model that is provided in the generating unit 204 and that generates a proposed photographing image and photographing parameters, and the learning method (the training method) of the trained model, will be described.

FIG. 5 shows a configuration example of the generating unit 204 that includes one trained model.

As shown in FIG. 5, a camera type and a lens type of the image pickup apparatus 1000 currently being used by the user, a prompt representing the user's preferences, a photographing effect value x, a live view image, and photographing parameters linked to the live view image become input data for the trained model. Here, the initial value of the photographing effect value x is 1, which is a maximum value, and when the position of the setting adjustment marker 402 shown in FIG. 4 is moved by a user operation, the value of the photographing effect value x is changed in accordance with the movement.

It should be noted that a plurality of trained models may be prepared for each of camera types and lens types. In this case, the prompt representing the user's preferences and the live view image are input as input data into one trained model that is to be used.

In addition, as shown in FIG. 5, one trained model included in the generating unit 204 outputs a proposed photographing image and photographing parameters as output data. With such a trained model, since the proposed photographing image and the photographing parameters are generated in close correlation with each other, the photographing result obtained when using the generated photographing parameters is a result closer to the proposed photographing image. On the other hand, when a plurality of tasks are assigned to one trained model, generally, the model size tends to become larger and the processing time tends to increase.

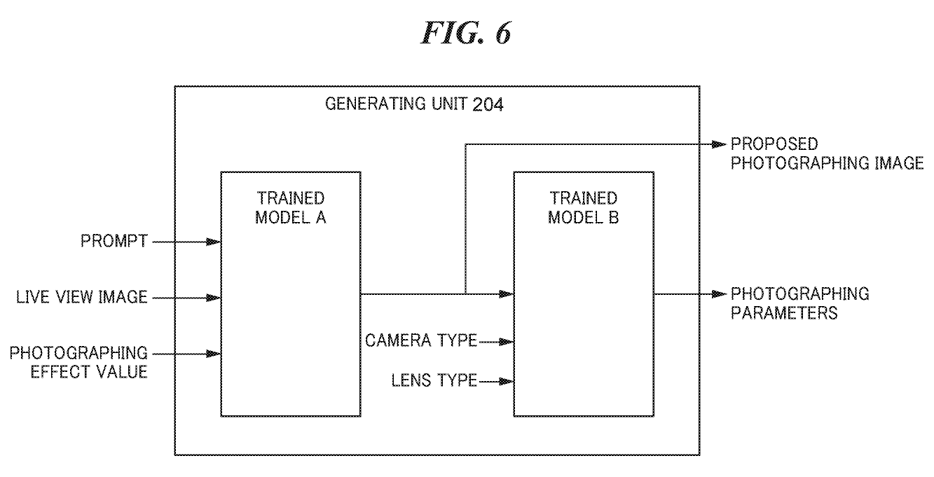

FIG. 6 shows a configuration example of the generating unit 204 that includes two trained models.

As shown in FIG. 6, first, when a prompt, a live view image, photographing parameters linked to the live view image, and a photographing effect value are input into a trained model A (a first trained model) as input data (first input data), a proposed photographing image is output as output data. Next, when the proposed photographing image output from the trained model A (second input data) and the camera type and the lens type of the image pickup apparatus 1000 currently being used by the user are input into a trained model B (a second trained model), photographing parameters are output as output data. In this configuration, the trained model A becomes a model that outputs a proposed photographing image that the photographing effect has been added to the input live view image, and the trained model B becomes a model that searches for photographing parameters for realizing the proposed photographing image. For this reason, the task is divided and simplified compared to the configuration shown in FIG. 5, and the processing accuracy for each task is capable of being improved.

In the first embodiment, the generating unit 204 is provided within the image pickup apparatus 1000, and since it is necessary to reduce the processing load, it is preferable to use the configuration example of FIG. 6 rather than the configuration example of FIG. 5.

Next, the learning method (the training method) of the first embodiment will be described.

The generating unit 204 of the first embodiment ultimately derives the photographing parameters, and therefore needs to calculate the photographing parameters that are based on the characteristics of the apparatus (the image pickup apparatus). In addition, it is also necessary for the user's request serving as the prompt in the form of input data to be reflected in the proposed photographing image and in the photographing parameters that are based on the proposed photographing image.

Therefore, a learning model that serves as the basis for a learned model (the trained model) to be used by the generating unit 204 is a model that uses information about the camera type and the lens type as input data and is capable of performing an inference processing specific to each camera type and each lens type. In addition, it is necessary to generate a proposed photographing image that matches the user's preferences serving as a prompt. Therefore, apart from the learning (the training) of the proposed photographing image and the photographing parameters, the trained model of the prompt generating unit 205 also completes learning (training) in advance to determine information about the photographing parameters by performing syntactic analysis of the prompt, etc.

First, the learning model that serves as the basis for the learned model (the trained model) to be used by the generating unit 204 is repeatedly trained by using a large number of photographed images (captured images) linked to photographing parameters as training data (teaching data), and a trained model, which is in an initial state, is constructed that, when a live view image is input, outputs photographing parameters and a proposed photographing image that are generally considered to be suitable. Furthermore, learning (training), which uses photographing parameters linked to a prompt as training data (teaching data), is performed, and additional learning (additional training), which uses the proposed photographing image output from the trained model as input data, is performed. When performing this learning, photographed images (captured images) that match the user's preferences are registered in advance in the generating unit 204. As a result, it is possible to make the trained model to be used by the generating unit 204 to become a trained model that matches the user's preferences. It should be noted that the registered photographed images described above may be prepared by the user himself/herself or may be presented by the generating unit 204. In the first embodiment, the photographed images presented by the generating unit 204 are selected by a photographer (the user) and registered in the generating unit 204.

In addition, the generating unit 204 performs the presentation of the photographed images in stages. In the first embodiment, as the photographed images to be registered in the generating unit 204, when the user selects the first photographed image, in order to narrow down the user's preferences, the generating unit 204 presents photographed images similar to the selected photographed image as options for the next photographed image to be registered, and prompts the user to make a selection. This step-by-step presentation may be continued until the generating unit 204 narrows down the user's preferences, or may be continued until the user instructs to end the registration midway.

By collecting photographed images to be registered in such a method and performing learning (training) in the generating unit 204, it becomes possible to generate a proposed photographing image that is closer to the user's preferences than a proposed photographing image generated by the trained model, which is in the initial state.

It should be noted that in the first embodiment, when the user is prompted to select registration information to be used for learning (training), the photographed images have been presented, but this is not limitative, and the user may be prompted to make the selection in the form of a text question.

However, the description so far is only for an initial setting. In reality, photographing will be performed many times starting from this initial setting state, and the results of these photographing will also be used for additional learning (additional training) of the trained model of the generating unit 204. The user repeats the adjustment of the proposed photographing image generated by the generating unit 204 and voice inputting of the request regarding the photographed image into the microphone 27. The proposed photographing image and the photographing parameters, which have been adopted by the user at this time, are used in association with the prompt, for additional learning (additional training) of the generating unit 204. By doing this, it is possible to generate a learning model that takes the user's preferences into further consideration.

In addition, a time series inference flag may be further added as input information, allowing to select whether or not to learn past user's proposed photographing images. This makes it possible to deal with a case where the user does not want the generating unit 204 to perform time series inference. In the first embodiment, the configuration is such that the user is able to instruct the generating unit 204 in advance whether or not to use the proposed photographing image that has been adjusted at the last minute for additional learning (additional training) of the trained model. It should be noted that the present disclosure is not limited to the first embodiment, and the trained model of the generating unit 204 may be configured to determine by itself whether or not the time series inference should be performed, or the trained model of the generating unit 204 may be a trained model that always performs the time series inference.

It should be noted that the user may be allowed to select an image to be used for additional learning (additional training) from among the proposed photographing images currently being adjusted.

As described above, the image pickup apparatus 1000 generates a proposed photographing image and photographing parameters for realizing photographing of this proposed photographing image based on a live view image before photographing and a prompt, displays the proposed photographing image, and also allows the user to adjust the photographing effect of the proposed photographing image. As a result, it is possible to provide a photographing assist function that is suitable for the user.

In addition, in the first embodiment, when a proposed photographing image is selected or determined by a user operation using the electronic dial 28 or the operation unit 29, the proposed photographing image may be displayed overlapping the live view image. As a result, the user is able to switch between the proposed photographing images while comparing them with the live view image, and is also able to select the proposed photographing image that best suits his or her preferences.

It should be noted that in the first embodiment, the start timing of the setting change processing of FIG. 3 has been set to a timing when the user's eye being in contact with the eyepiece sensor 26 is detected, but is not limited to this timing. For example, the setting change processing of FIG. 3 may be always continuously executed from a timing when the obtainment of a live view image is started.

As described above, according to the first embodiment, even a user who is unfamiliar with photographing becomes able to easily take a photograph as intended by himself/herself. In addition, since photographing parameters are automatically generated by using the machine learning algorithm, an optimal setting is suggested for each photographing scene, improving the quality of the photographing result.

Although the first embodiment has been described above in detail, the present disclosure is not limited to a specific embodiment, and various modifications and variations are possible within the scope of the claims. In addition, it is also possible to combine all or a plurality of components of the first embodiment.

For example, in the first embodiment, the example has been described in which a proposed photographing image is displayed and the user operates the setting adjustment marker 402. However, it is also possible for the user to move the position of the setting adjustment marker 402 left or right without displaying the proposed photographing image, and for the generating unit 204 to generate photographing parameters, for which the photographing effect has been adjusted, in accordance with the position of the setting adjustment marker 402 after the movement.

Regardless of whether or not a proposed photographing image is displayed to the user through the display unit, since the generating unit 204 generates photographing parameters related to the proposed photographing image, it is not necessarily necessary to present the proposed photographing image to the user.

Hereinafter, a second embodiment of the present disclosure will be described. An image pickup apparatus 1001 according to the second embodiment differs from the image pickup apparatus 1000 according to the first embodiment in that the image pickup apparatus 1001 does not include the generating unit 204. In addition, the image pickup apparatus 1001 according to the second embodiment differs from the image pickup apparatus 1000 according to the first embodiment in that the generation processing executed by the generating unit 204 is executed by an external generating apparatus 1002 connected to the image pickup apparatus 1001.

In other words, the second embodiment is executed by an image pickup system configured to include the image pickup apparatus 1001 and the generating apparatus 1002.

It should be noted that in the second embodiment, the same configurations (components) and steps (processes) as those in the first embodiment are given the same reference numerals, and duplicate descriptions will be omitted.

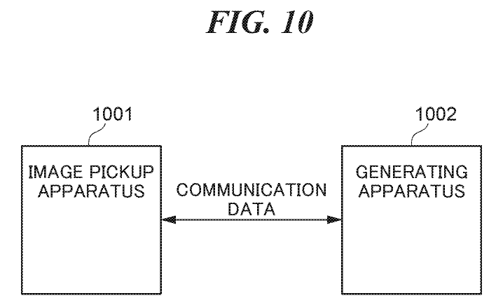

As described above, the generating unit 204 according to the first embodiment preferably includes two trained models (see FIG. 6). This is because the processing load of the processing performed by the generating unit 204 is greater than the processing load of general image processing and the like that are performed by the image pickup apparatus. For this reason, in the second embodiment, the processing performed by the generating unit 204 is executed by the generating apparatus 1002 (see FIG. 10) that is an apparatus separate from the image pickup apparatus 1001.

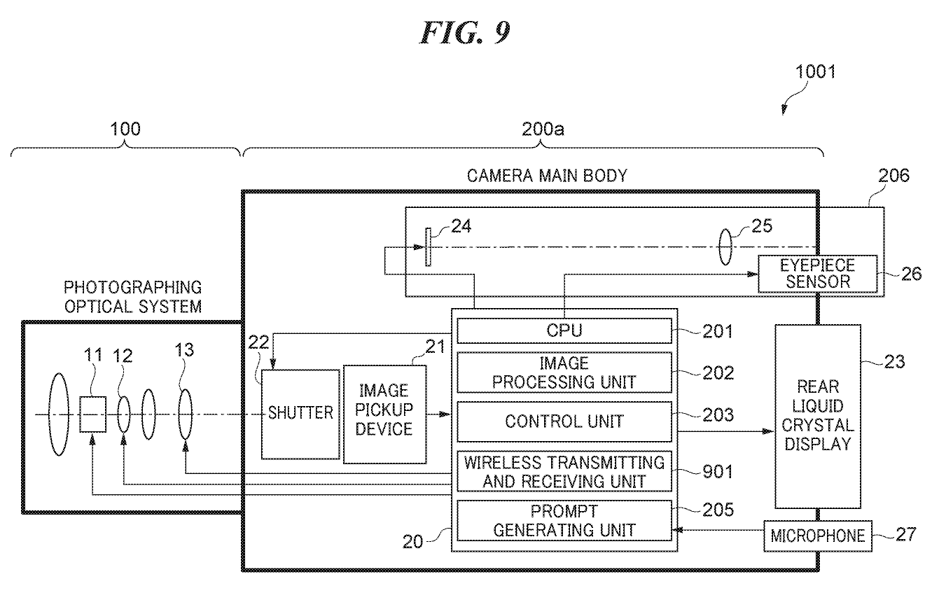

FIG. 9 is a block diagram that illustrates a hardware configuration of the image pickup apparatus 1001 in the second embodiment. Hereinafter, the components of the image pickup apparatus 1001 that are the same as those in FIG. 1A, FIG. 1B, and FIG. 2 will be denoted by the same reference numerals, and duplicate descriptions will be omitted.

As shown in FIG. 9, the image pickup apparatus 1001 does not include the generating unit 204, but instead includes a wireless transmitting and receiving unit 901. The wireless transmitting and receiving unit 901 is capable of transmitting and receiving data to and from an external apparatus, and the image pickup apparatus 1001 uses the wireless transmitting and receiving unit 901 to perform data communication with the generating apparatus 1002 (see FIG. 10) that will be described below.

FIG. 10 is a diagram that illustrates the configuration of the image pickup system according to the second embodiment of the present disclosure.

The image pickup system shown in FIG. 10 is configured to include the image pickup apparatus 1001 that has been described above with reference to FIG. 9 and the generating apparatus 1002, which are communicably connected to each other. The generating apparatus 1002 is an apparatus capable of executing the same processing as the generating unit 204 that is shown in the first embodiment, and includes a generating unit and a wireless transmitting and receiving unit, which are not shown.

In the image pickup system shown in FIG. 10, the generating apparatus 1002 takes charge of the processing executed by the generating unit 204 that is shown in the first embodiment. For this reason, the image pickup apparatus 1001 transmits, as communication data, a live view image, voice data, a prompt, a photographing effect value, photographing parameters linked to the live view image, and a time series inference flag to the generating apparatus 1002 via the wireless transmitting and receiving unit 901. On the other hand, an inference processing using the communication data transmitted from the image pickup apparatus 1001 as input data is executed by the generating unit (not shown) of the generating apparatus 1002 to generate a proposed photographing image and photographing parameters, and the generating apparatus 1002 transmits, to the image pickup apparatus 1001, the proposed photographing image and the photographing parameters, which have been generated. The other processes are the same as in the first embodiment.

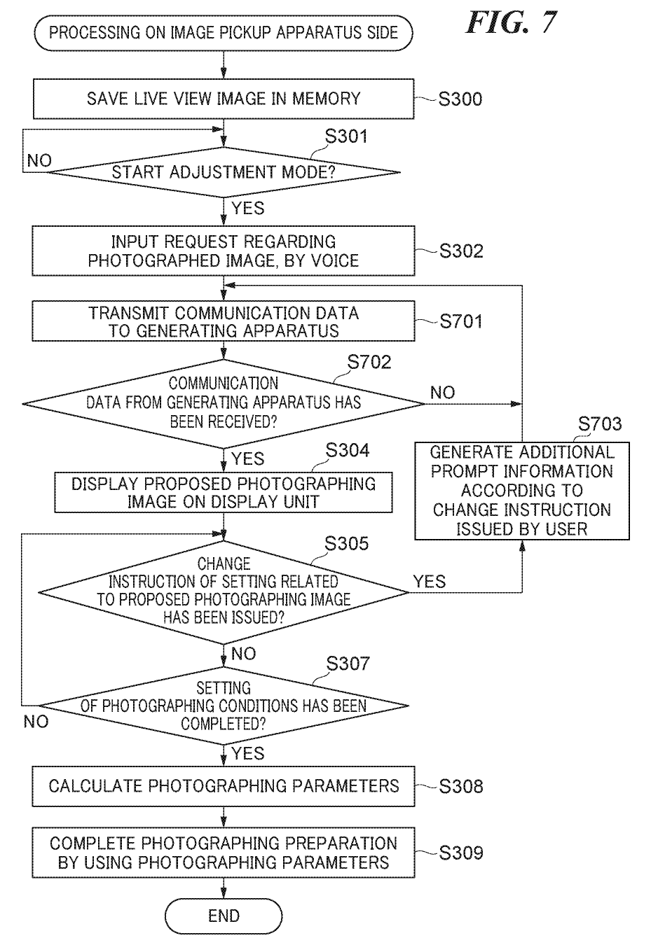

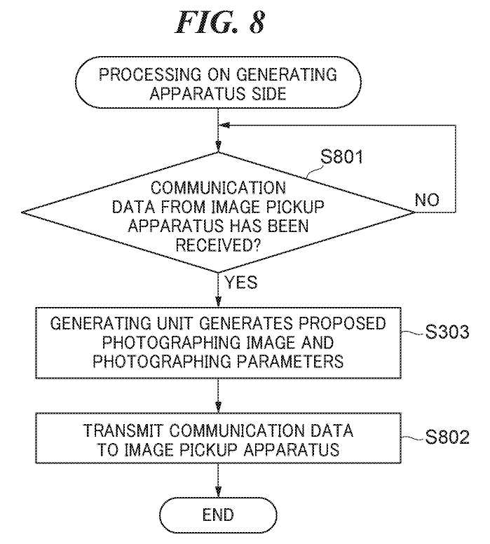

Next, the processing of the image pickup system in the second embodiment, which is realized by communications (interactions) between the side of the image pickup apparatus 1001 and the side of the generating apparatus 1002, will be described with reference to a flowchart of FIG. 7 and a flowchart of FIG. 8. It should be noted that the same steps (processes) as those in the first embodiment are given the same reference numerals, and duplicate descriptions will be omitted.

Similar to the setting change processing of FIG. 3, a setting change processing performed on the side of the image pickup apparatus 1001 of the image pickup system according to the second embodiment (hereinafter, simply referred to as “a setting change processing of FIG. 7”) is realized by the CPU 201 sending commands to the control unit 203 and controlling the respective units (the respective components) of the image pickup apparatus 1001. In addition, in the second embodiment, the setting change processing of FIG. 7 is started when the user's eye being in contact with the eyepiece sensor 26 is detected.

As shown in FIG. 7, first, the processes of the steps S300 to S302 are executed, and then the setting change processing of FIG. 7 proceeds to a step S701.

In the step S701, the control unit 203 transmits communication data to the generating apparatus 1002 via the wireless transmitting and receiving unit 901 (a first data transmitting and receiving unit). As the communication data (first communication data), voice data of a request regarding a proposed photographing image vocalized by the user, a prompt generated from the voice data by the prompt generating unit 205, a live view image, etc. are transmitted to the generating apparatus 1002.

In a step S702, the control unit 203 determines whether or not a proposed photographing image and photographing parameters have been received as communication data from the generating apparatus 1002 via the wireless transmitting and receiving unit 901 (the first data transmitting and receiving unit). This communication data is transmitted to the image pickup apparatus 1001 in a step S802 of FIG. 8, which will be described below. In the case of being determined that the communication data from the generating apparatus 1002 has been received (YES in the step S702), the process of the step S304 is executed, and the setting change processing of FIG. 7 proceeds to the step S305. On the other hand, in the case of being determined that the communication data from the generating apparatus 1002 has not been received (NO in the step S702), the setting change processing of FIG. 7 returns to the step S701.

In the step S305, as in the first embodiment, the control unit 203 determines whether or not an instruction to change a setting related to the proposed photographing image (an instruction to change the photographing effect value x) has been issued by the user, that is, determines whether or not a change instruction of the setting related to the proposed photographing image has been issued by the user. However, in the case of being determined that a change instruction of the setting related to the proposed photographing image has been issued (YES in the step S305), the setting change processing of FIG. 7 proceeds to a step S703, and on the other hand, in the case of being determined that a change instruction of the setting related to the proposed photographing image has not been issued (NO in the step S305), the setting change processing of FIG. 7 proceeds to the step S307.

In the step S703, the control unit 203 generates an additional prompt that includes the photographing effect value x determined in accordance with the position of the setting adjustment marker 402. As a result, similar to the first embodiment, in the case where the user has changed the setting related to the proposed photographing image (the photographing effect) in the step S305, the photographing effect of the proposed photographing image is changed as intended by the user. Thereafter, the setting change processing of FIG. 7 returns to the step S701, and the control unit 203 transmits the additional prompt to the generating apparatus 1002 via the wireless transmitting and receiving unit 901 (a second data transmitting and receiving unit), and obtains, from the generating apparatus 1002, a proposed photographing image and photographing parameters, in which the photographing effect has been adjusted. Here, the photographing effect value x included in the additional prompt is information indicating the magnitude of the photographing effect compared to the proposed photographing image that has been displayed as the faithful setting (compared to the live view image).

Next, a setting change processing performed on the side of the generating apparatus 1002 of the image pickup system according to the second embodiment (hereinafter, simply referred to as “a setting change processing of FIG. 8”) will be described with reference to FIG. 8.

The setting change processing of FIG. 8 is realized by a CPU (not shown) of the generating apparatus 1002 controlling the respective units (the respective components) of the generating apparatus 1002.

As shown in FIG. 8, in a step S801, it is determined whether or not communication data from the image pickup apparatus 1001 has been received by the wireless transmitting and receiving unit (not shown) of the generating apparatus 1002. The communication data here refers to the data transmitted from the image pickup apparatus 1001 in the step S701 that has been described above. In the case of being determined that the communication data from the image pickup apparatus 1001 has been received (YES in the step S801), the setting change processing of FIG. 8 proceeds to the step S303, where the generating unit (not shown) of the generating apparatus 1002 generates a proposed photographing image and photographing parameters, and then the setting change processing of FIG. 8 proceeds to the step S802. On the other hand, in the case of being determined that the communication data from the image pickup apparatus 1001 has not been received (NO in the step S801), the setting change processing of FIG. 8 returns to the step S801.

In the step S802, the proposed photographing image and the photographing parameters, which have been generated by the generating unit (not shown) of the generating apparatus 1002 in the step S303, are transmitted as communication data to the image pickup apparatus 1001, and the setting change processing of FIG. 8 ends. The setting change processing on the side of the generating apparatus 1002 shown in FIG. 8 is repeatedly executed until the generating apparatus 1002 is shut down.

As described above, in the second embodiment, the processing with a large processing load, which is executed by the generating unit 204 in the first embodiment, is executed not by the image pickup apparatus 1001 but by the generating apparatus 1002, which is a separate apparatus. As a result, it is possible to reduce the processing load on the image pickup apparatus 1001. Furthermore, by independently providing the generating apparatus 1002 as an apparatus that executes the above-described processing with a large processing load, it becomes possible to easily update the trained model used in the above-described processing with a large processing load, making it possible to easily improve the performance of the above-described processing with a large processing load.

It should be noted that even in a configuration in which the above-described processing with a large processing load is executed by the generating unit 204 as in the image pickup apparatus 1001 of the first embodiment, performing updating of the trained model by, for example, downloading a trained model via a network is within the scope of the second embodiment.

In addition, the image pickup apparatus according to the present disclosure is not limited to an apparatus having only a photographing function, such as the image pickup apparatus 1000 according to the first embodiment or the image pickup apparatus 1001 according to the second embodiment, but may also be an information processing apparatus provided with functions other than the photographing function, such as a smartphone.

According to the present disclosure, even a user who is unfamiliar with photographing is able to easily take a photograph as intended by himself/herself.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read-only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-205470, filed November 26, 2024, which is hereby incorporated by reference herein in its entirety.

What is claimed is:

1. An image pickup apparatus comprising:
an image sensor;
a request obtaining unit configured to obtain a request for a photographing effect from a user;
at least one processor and/or circuit configured to function as:
a converting unit that converts the request for the photographing effect into a prompt;
a first generating unit that generates, as output data, photographing parameters and a proposed photographing image, in which the photographing effect becomes maximum, by using a machine learning algorithm from input data including a live view image that has been obtained by the image sensor, photographing parameters linked to the live view image, and the prompt;
an adjustment component that adjusts the photographing effect in a range from zero to maximum in response to a first user operation;
a second generating unit that generates photographing parameters with which the adjusted photographing effect is capable of being obtained by using the machine learning algorithm; and
a photographing preparation unit that, when a second user operation is performed, performs a photographing preparation by using the photographing parameters with which the adjusted photographing effect is capable of being obtained; and
an image display unit configured to display at least the live view image in which the photographing effect is zero and the proposed photographing image in which the photographing effect becomes maximum in a switchable manner.

2. The image pickup apparatus according to claim 1, further comprising:
an adjustment screen display unit configured to display an adjustment bar for adjusting the photographing effect in the range from zero to maximum and a marker on the adjustment bar that indicates a current photographing effect, and
the first user operation is an operation of moving a position of the marker on the adjustment bar.

3. The image pickup apparatus according to claim 1, wherein
the machine learning algorithm uses a trained model, which has been repeatedly trained by using, as training data, photographed images linked to photographing parameters, in an initial state.

4. The image pickup apparatus according to claim 3, wherein
the trained model is constructed in accordance with a camera type and a lens type of the image pickup apparatus.

5. The image pickup apparatus according to claim 3, wherein
the input data includes a photographing effect value indicating a magnitude of the photographing effect, and
an initial value of the photographing effect value is a maximum value.

6. The image pickup apparatus according to claim 5, wherein
the trained model is configured by one trained model that, when input data including the live view image, the photographing parameters linked to the live view image, the prompt, and the photographing effect value is input, outputs, as output data, photographing parameters with which a photographing effect indicated by the photographing effect value is capable of being obtained and a proposed photographing image in which the photographing effect indicated by the photographing effect value is capable of being obtained.

7. The image pickup apparatus according to claim 5, wherein
the trained model is configured by a first trained model that, when first input data including the live view image, the photographing parameters linked to the live view image, the prompt, and the photographing effect value is input, outputs, as output data, a proposed photographing image in which a photographing effect indicated by the photographing effect value is capable of being obtained, and a second trained model that, when second input data including the proposed photographing image output from the first trained model is input, outputs, as output data, photographing parameters with which the photographing effect indicated by the photographing effect value is capable of being obtained.

8. The image pickup apparatus according to claim 1, wherein
the adjustment component adjusts a plurality of camera setting items that affect the photographing effect as the photographing parameters.

9. The image pickup apparatus according to claim 8, wherein
the camera setting items include at least one of a shutter speed, an aperture value, an ISO sensitivity, white balance, exposure, image contrast, saturation, sharpness, lighting correction, tone priority, photographing style, noise reduction, color correction, a subject tracking setting, a focus setting, and an image processing setting.

10. The image pickup apparatus according to claim 1, wherein
the second generating unit further outputs a proposed photographing image, in which the adjusted photographing effect is capable of being obtained, by using the machine learning algorithm every time the photographing effect is adjusted by the adjustment component, and
the image display unit updates a display to the proposed photographing image, in which the adjusted photographing effect is capable of being obtained.

11. The image pickup apparatus according to claim 10, wherein
the image display unit changes an update speed of the display to the proposed photographing image, in which the adjusted photographing effect is capable of being obtained, in accordance with an operation speed of the first user operation.

12. The image pickup apparatus according to claim 11, wherein
in a case where the operation speed of the first user operation is smaller than a threshold value, the update speed is increased, and in a case where the operation speed of the first user operation is equal to or greater than the threshold value, the update speed is decreased.

13. The image pickup apparatus according to claim 1, wherein
the image display unit is at least one of a rear panel and an electronic viewfinder (EVF).

14. The image pickup apparatus according to claim 1, wherein
the request obtaining unit obtains voice vocalized by the user and obtains the request as character-recognized voice data.

15. An image pickup apparatus connected to a generating apparatus, the image pickup apparatus comprising:
an image sensor;
a request obtaining unit configured to obtain a request for a photographing effect from a user;
at least one processor and/or circuit configured to function as:
a converting unit that converts the request for the photographing effect into a prompt;
a first data transmitting and receiving unit that transmits, to the generating apparatus, first communication data including a live view image that has been obtained by the image sensor, photographing parameters linked to the live view image, and the prompt, and receives, from the generating apparatus, photographing parameters and a proposed photographing image, in which the photographing effect becomes maximum, the photographing parameters and the proposed photographing image being generated by using a machine learning algorithm from the first communication data;
an adjustment component that adjusts the photographing effect in a range from zero to maximum in response to a first user operation;
a second data transmitting and receiving unit that transmits, to the generating apparatus, a photographing effect value indicating a magnitude of the adjusted photographing effect, and receives, from the generating apparatus, photographing parameters with which the adjusted photographing effect is capable of being obtained and a proposed photographing image in which the adjusted photographing effect is capable of being obtained, the photographing parameters and the proposed photographing image being generated by using the machine learning algorithm from the photographing effect value; and
a photographing preparation unit that, when a second user operation is performed, performs a photographing preparation by using the photographing parameters with which the adjusted photographing effect is capable of being obtained; and
an image display unit configured to display at least the live view image in which the photographing effect is zero and the proposed photographing image in which the photographing effect becomes maximum in a switchable manner.

16. A control method comprising:
a photographing step;
a request obtaining step of obtaining a request for a photographing effect from a user;
a converting step of converting the request for the photographing effect into a prompt;
a first generating step of generating, as output data, photographing parameters and a proposed photographing image, in which the photographing effect becomes maximum, by using a machine learning algorithm from input data including a live view image that has been obtained in the photographing step, photographing parameters linked to the live view image, and the prompt;
an image display step of displaying at least the live view image in which the photographing effect is zero and the proposed photographing image in which the photographing effect becomes maximum in a switchable manner;
an adjustment step of adjusting the photographing effect in a range from zero to maximum in response to a first user operation;
a second generating step of generating photographing parameters with which the adjusted photographing effect is capable of being obtained by using the machine learning algorithm; and
a photographing preparation step of, when a second user operation is performed, performing a photographing preparation by using the photographing parameters with which the adjusted photographing effect is capable of being obtained.

17. A control method for an image pickup apparatus connected to a generating apparatus, the control method comprising:
a photographing step;
a request obtaining step of obtaining a request for a photographing effect from a user;
a converting step of converting the request for the photographing effect into a prompt;
a first data transmitting and receiving step of transmitting, to the generating apparatus, first communication data including a live view image that has been obtained in the photographing step, photographing parameters linked to the live view image, and the prompt, and receiving, from the generating apparatus, photographing parameters and a proposed photographing image, in which the photographing effect becomes maximum, the photographing parameters and the proposed photographing image being generated by using a machine learning algorithm from the first communication data;
an image display step of displaying at least the live view image in which the photographing effect is zero and the proposed photographing image in which the photographing effect becomes maximum in a switchable manner;
an adjustment step of adjusting the photographing effect in a range from zero to maximum in response to a first user operation;
a second data transmitting and receiving step of transmitting, to the generating apparatus, a photographing effect value indicating a magnitude of the adjusted photographing effect, and receiving, from the generating apparatus, photographing parameters with which the adjusted photographing effect is capable of being obtained and a proposed photographing image in which the adjusted photographing effect is capable of being obtained, the photographing parameters and the proposed photographing image being generated by using the machine learning algorithm from the photographing effect value; and
a photographing preparation step of, when a second user operation is performed, performing a photographing preparation by using the photographing parameters with which the adjusted photographing effect is capable of being obtained.

18. A non-transitory computer-readable storage medium storing a program for causing a computer to execute a control method, the control method comprising:
a photographing step;
a request obtaining step of obtaining a request for a photographing effect from a user;
a converting step of converting the request for the photographing effect into a prompt;
a first generating step of generating, as output data, photographing parameters and a proposed photographing image, in which the photographing effect becomes maximum, by using a machine learning algorithm from input data including a live view image that has been obtained in the photographing step, photographing parameters linked to the live view image, and the prompt;
an image display step of displaying at least the live view image in which the photographing effect is zero and the proposed photographing image in which the photographing effect becomes maximum in a switchable manner;
an adjustment step of adjusting the photographing effect in a range from zero to maximum in response to a first user operation;
a second generating step of generating photographing parameters with which the adjusted photographing effect is capable of being obtained by using the machine learning algorithm; and
a photographing preparation step of, when a second user operation is performed, performing a photographing preparation by using the photographing parameters with which the adjusted photographing effect is capable of being obtained.

19. A non-transitory computer-readable storage medium storing a program for causing a computer to execute a control method for an image pickup apparatus connected to a generating apparatus, the control method comprising:
a photographing step;
a request obtaining step of obtaining a request for a photographing effect from a user;
a converting step of converting the request for the photographing effect into a prompt;
a first data transmitting and receiving step of transmitting, to the generating apparatus, first communication data including a live view image that has been obtained in the photographing step, photographing parameters linked to the live view image, and the prompt, and receiving, from the generating apparatus, photographing parameters and a proposed photographing image, in which the photographing effect becomes maximum, the photographing parameters and the proposed photographing image being generated by using a machine learning algorithm from the first communication data;
an image display step of displaying at least the live view image in which the photographing effect is zero and the proposed photographing image in which the photographing effect becomes maximum in a switchable manner;
an adjustment step of adjusting the photographing effect in a range from zero to maximum in response to a first user operation;
a second data transmitting and receiving step of transmitting, to the generating apparatus, a photographing effect value indicating a magnitude of the adjusted photographing effect, and receiving, from the generating apparatus, photographing parameters with which the adjusted photographing effect is capable of being obtained and a proposed photographing image in which the adjusted photographing effect is capable of being obtained, the photographing parameters and the proposed photographing image being generated by using the machine learning algorithm from the photographing effect value; and
a photographing preparation step of, when a second user operation is performed, performing a photographing preparation by using the photographing parameters with which the adjusted photographing effect is capable of being obtained.
